(19) United States
(12) Patent Application Publication
(10) Pub. No.: US 2014/0046855 A1
(43) Pub. Date: Feb. 13, 2014

(54) DATA COMMUNICATION SYSTEM USING PROXIMITY AUTHENTICATION

(71) Applicant: SnowShoeFood, LLC, Madison, WI (US)

(72) Inventor: Claus C. Moberg, Madison, WI (US)

(73) Assignee: SnowShoeFood, LLC, Madison, WI (US)

(21) Appl. No.: 13/961,392

(22) Filed: Aug. 7, 2013

Related U.S. Application Data
(60) Provisional application No. 61/680,602, filed on Aug. 7, 2012.

(51) Int. Cl. G06Q 20/32

(52) U.S. Cl. CPC G06Q 20/3278
USPC 705/71; 705/44

(57) ABSTRACT

A touchscreen input device providing a predetermined pattern of “touches” on a touchscreen provides proximity authentication to a mobile device communicating with a terminal such as a vending machine or the like. A “point configuration” generated on the mobile device by the touchscreen input device ma be communicated to a coordinating computer that matches the point configuration to the point configuration of the terminal to determine that the mobile device is proximate to the terminal. This proximity may be used as a requirement to complete the vending machine transaction or further data communication between the mobile device and the terminal.

### CROSS REFERENCE TO RELATED APPLICATIONS

This application claims the benefit of U.S. provisional application 61/680,602 filed Aug. 7, 2012 and hereby incorporated by reference

### BACKGROUND OF THE INVENTION

The present invention relates to an authentication system using established proximity of communicating devices to provide enhanced security, functionality or certainty in data transactions.

Many types of electronic transactions desirably establish proximity between the two communicating devices. This proximity limits possible fraudulent communication between one of the devices and an eavesdropping device and also reduces the possibility of miscommunication between a given device and an unintended device.

For example, when a cell phone is used to make a purchase from a vending machine, it may be desirable to limit this activity to only when the cell phone is proximate to the vending machine. Requiring proximity ensures that the transaction is consummated with the correct vending machine and not a nearby vending machine and limits interception of or interference with the transactional information communicated between the two devices.

One method of introducing a proximity element into data communications is through the use of near field communication (NFC) technologies. Such technologies employ a communication channel that is inherently limited in distance, for example, to less than two meters.

Not all mobile devices have NFC capability and existing devices may have incompatible NFC technologies. Further, despite the potential convenience of NFC transactions, many consumers may be understandably uncertain about such a system and concerned about accidental charges or mistaken charges particularly in the presence of multiple near field devices.

### SUMMARY OF TIME INVENTION

The present invention provides a “touchscreen interface device” that establishes proximity as a condition to data communication or completion of a transaction and thus which may serve as an alternative to NFC techniques or a way of augmenting NFC communication for additional security or accuracy. The touchscreen interface device provides a set of touch points that when pressed against the touchscreen of the smart phone imparts information from a unique constellation of touch points (a point configuration). This point configuration may be verified against a known point configuration of the stamp key associated with a terminal holding the touchscreen interface device as a predicate to data communication and as a mechanism for providing security in subsequent data communication. The point configuration both establishes close proximity of the two devices (touching) and intent of the user to initiate communication (by the physical effort of the touching).

Specifically, the present invention provides, in one embodiment, an authenticating system for communication between a portable device and a terminal. The portable device may include a wireless communication circuit for communicating with the portable electronic device and a touchscreen input device for communicating with the portable electronic device via touches on the touch screen. The terminal system may include a stamp key for contacting a touchscreen to generate a multitouch point configuration on the touchscreen of multiple touch points having predetermined relative displacements, a communication circuit receiving communications from the wireless communication circuit of a portable device, and a processor.

The processor may execute a stored program to receive the point configuration from the portable device when the portable device has its touchscreen pressed against the stamp key via the communication circuit together with a unique identifier of the portable device, and compare the point configuration to the stamp key and, if they match, communicate data with the portable device using the communication circuit on a channel authenticated to the unique identifier of the portable device.

It is thus a feature of at least one embodiment of the invention to provide a highly localized authentication of data communications to proximate devices. The touchscreen interface device not only requires actual touching of the mobile device to a particular location but produces a point configuration that is highly specific as opposed to, for example, an accelerometer “bump” sometimes used for localization.

The wireless communication circuit in the communication circuit employs a near field communication channel having a working range of less than 2 meters.

It is thus a feature of at least one embodiment of the invention to provide a system for enhancing the security of near field communication systems.

The near field communication circuit may use a low power radio frequency signal.

It is thus a feature of at least one embodiment of the invention to overcome the difficulties of establishing distance limitations with radiofrequency signals particularly in areas crowded with near field communication devices,

The stamp key may be spatially associated with the communication circuit.

It is thus a feature of at least one embodiment of the invention to ensure proximity with respect to the communication circuit, for example, in a near field communication application.

The data communicated by the communication circuit and the touches on the touch screen from the touchscreen input device must occur within a predetermined time window. In addition or alternatively, the authentication must be repeated after a predetermined time of ceasing of data communication between the terminal system and the portable device.

It is thus a feature of at least one embodiment of the invention to augment the position proximity with a time proximity.

The terminal system may be associated with a vending machine and the data communication may relate to purchase of product from the vending machine including identification of a payment source and a release of product from the vending machine. The vending machine may dispense a product selected from the group consisting of a food, a beverage, cash, and physical tickets.

It is thus a feature of at least one embodiment of the invention to provide improved security and accuracy for purchases from vending machines.

The stamp key may be attached to a housing of the vending machine.

It is thus a feature of at least one embodiment of the invention to allow use of the stamp key from a position convenient to use of the vending machine.

The processor may be within the terminal or may be remote from the terminal communicating with the terminal via a wireless communication channel.

It is thus a feature of at least one embodiment of the invention to provide the security of spatial localization regardless of the actual position of the authenticating terminal computer.

The point configuration and the unique identifier portable device may be encrypted, for example, using public key encryption.

It is thus a feature of at least one embodiment of the invention to limit the possibility of capture of the key code thus improving the security inherent in the physical presence required by the stamp key.

These particular objects and advantages may apply to only some embodiments falling within the claims and thus do not define the scope of the invention.

### BRIEF DESCRIPTION OF THE DRAWINGS

FIG. 1 is a perspective view of a smart phone used by a consumer for a vending machine transaction showing location of the near field communication device for communicating with the phone and a physical touchscreen interface device of the present invention;

FIG. 2 is a detailed fragmentary view of the physical touchscreen interface device;

FIG. 3 is a block diagram of the communicating elements of the vending transaction showing data communication from the smart phone to the near field device and optionally through a secondary radio channel to a commerce computer;

FIG. 4 is a simplified flowchart of the validation process incorporating both the touchscreen interface device of the present invention and near field communication; and

FIG. 5 is a data flow diagram of use of the present invention to simulate near field communication with standard wireless or cell phone data channels.

### DETAILED DESCRIPTION OF THE PREFERRED EMBODIMENT

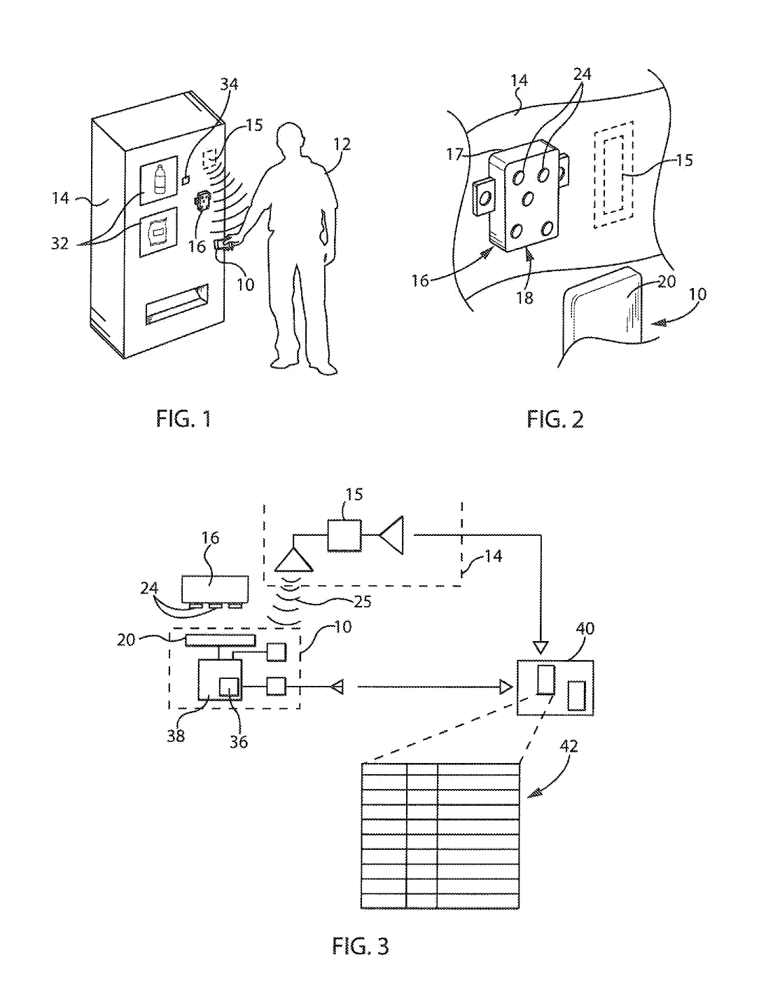

Referring now to FIG. 1, a smart phone 10 or similar mobile wireless device may be employed by a user 12 to effect a purchase of a product from a vending machine 14 or the like by means of communication between the smart phone 10 and a near field transceiver 15 of a type known in the art. The near field transceiver 15 may be embedded within or affixed to the vending machine 14 and may be largely invisible to the user 12 except for its interaction with the smart phone 10, for example, via an application program running on the smart phone 10.

Examples of near field transceivers include those using radio-frequency identification (RFID) standards including ISO/IEC 14443 and FeliCa, other magnetic induction systems, infrared data transmissions systems using low powered infrared light emitting diodes, and optical systems, for example those using bar codes and cameras. The present invention may also work with local communication systems such as IEEE 802.11 (Wi-Fi) and Bluetooth and even standard cell phone data transmission protocols.

Referring also to FIG. 2, a touchscreen interface device 16 may be fixed to the vending machine 14 or in close proximity thereto to be spatially associated with respect to the vending machine 14. Normally the touchscreen interface device 16 will be attached to a front face of the vending machine housing. Spatially associated means that the touchscreen interface device 16 is positioned so that a user of the touchscreen interface device 16 would be able to use and identify the particular vending machine with which the touchscreen interface device 16 is associated.

The touchscreen interface device 16 may provide for a conductive body 17, for example a milled aluminum block or molded or printed conductive plastic, to present a front face 18 having an area that may be received by a touchscreen 20 of the smart phone 10. Typically the touchscreen interface device 16 will be within two meters and more preferably within ten centimeters of the controls of the vending machine 14 used for ordering product or its dispensing openings.

The front face 18 of the touchscreen interface device 16 may have multiple projecting contact pads 24 that when placed in contact with the touchscreen 20 register as if they were finger touches. A touchscreen interface device of this type is described by co-pending U.S. patent application Ser. No. 13/385,049 entitled: “Tool and Method for Authenticating Transactions”, filed Jan, 31, 2012, and assigned to the same assignee as the present invention and is hereby incorporated by reference.

As described in the above-referenced co-pending application, each of these touches may be registered by the smart phone 10 running an application program to uniquely identify the touchscreen interface device 16 by the spatial separations and orientations of the touches. Generally, the contact pads 24 are electrically interconnected through the conductive body 17 which provides a capacitive effect similar to that of finger touches at the contact pads 24. The interface device may be connected by a capacitor to a voltage reference such as ground. The spatial separations and orientations of the touches establish a point configuration typically unique to the touchscreen interface device 16.

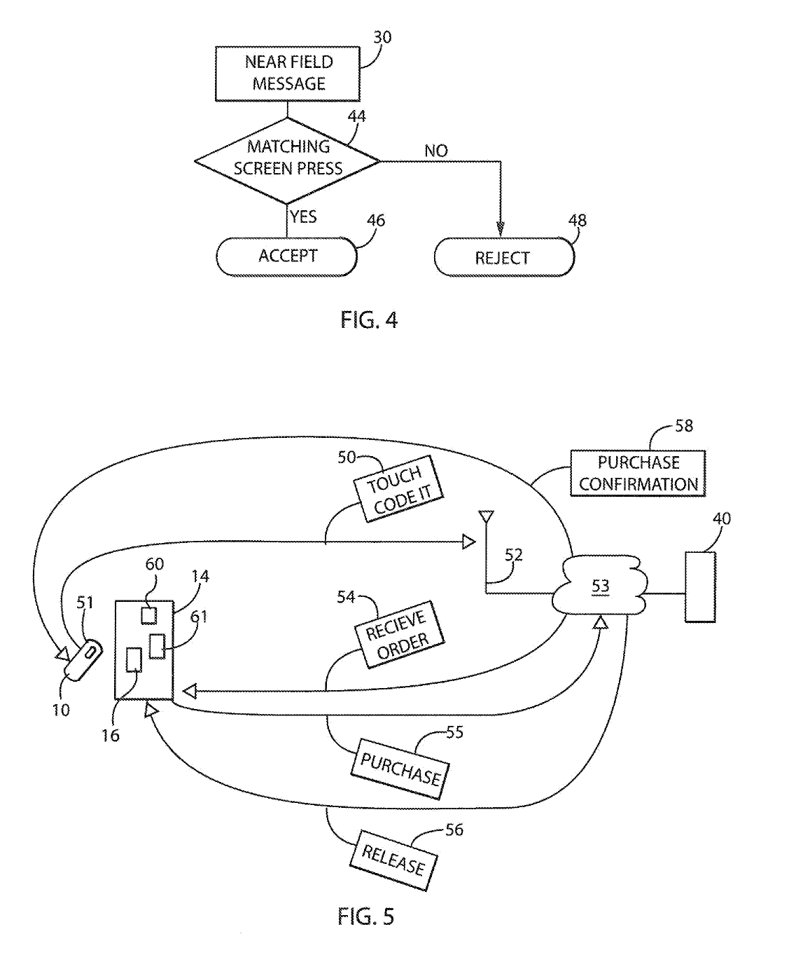

Referring now to FIGS. 1, 3 and 4, during the transaction of FIG. 1, a near field communication 25 may be initiated between the smart phone 10 and the near field transceiver 15 as indicated by process block 30. This near field communication may, in fact, be triggered by identification of a product 32 in the vending machine by the user 12 14 and indicating that selection, for example, by a vending machine button 34. In response to that selection or indication, a near field communication application program 36 running on a processor 38 within the smart phone 10 may provide a display on the touchscreen 20 indicating to the user that they should press the touchscreen 20 against the contact pads 24 of the interface device 16 for confirmation of the purchase.

The pattern of touches or point configuration registered in this action may be sent to a separate commerce computer 40 which also receives information from the near field transceiver 15. The commerce computer 40 may consult with a database 42 matching a particular constellation of touches communicated from the smart phone 10 to a near field communication identification number identifying the vending machine 14. This process confirms that there is a matching screen press as indicated by decision block 44 contemporaneous with the near field communication for the correct machine. Upon such confirmation, as indicated by process block 46, a purchase may be accepted and the necessary debit entered into the user's account. At this time the vending machine 14 may be authorized to release the product to the user 12. If there is no match, the purchase is rejected as indicated by process block 48.

Referring now to FIG. 5, more generally, the present invention may provide for a proximity verified data communication channel that does not necessarily require near field communication technology. In this way, conflicting standards related to near field communication technology need not limit adoption of the system, and versatile Wi-Fi or cell phone data communication may be used in lieu of NFC communication,

In this case, upon a pressing of the smart phone 10 touchscreen 20 against the interface device 16, an application program 51 running on the smart phone 10 may provide for a communication of the point configuration and a unique identifier of the smart phone 10 as indicated by message 50 to the commerce computer 40. The unique identifier of the smart phone 10 may be, for example, a MAC address or serial number of the smart phone 10 or the like. This communication may be made, for example, through cell phone data channels to a cell phone tower 52 and ultimately to the Internet 53 to be received by the commerce computer 40.

Alternative communication channels, for example, may make use of local Wi-Fi connections including, for example, using a Wi-Fi receiver in the vending machine 14. The point configuration and unique identifier may be encrypted, for example, using a public-key encryption or the like with a public-key provided by the vending machine 14. A timestamp may be linked to the point configuration at the time the smart phone 10 receives the point configuration by being placed against the interface device 16 and this timestamp may also be transmitted. If the transmission of the point configuration is not received within a predetermined time, for example thirty seconds, the point configuration may be rejected as stale and the consumer instructed to try again by again pressing the touchscreen 20 against the touch interface device 16.

If the point configuration received by the commerce computer 40 matches the known point configuration of the vending machine 14, the commerce computer 40 may initiate a receive order message 54 transmitted to the vending machine 14, for example, via any communication channel including but not limited to a wired Internet connection, wireless connection, or cell phone data connection. This receive order message 54 may, for example, provide an indication on a display screen 61 or the like on the vending machine 14 that the user of the smart phone 10 is now authorized to make an order, for example, by pressing controls on the vending machine 14. Alternatively, the accept order message 54 may be transmitted to the application program 51 running on the smart phone 10 to similar effect (that is, providing a message on the smart phone display).

It will be appreciated that the receive order message 54 may alternatively be used to authorize and establish secure communication between the smart phone 10 and a device standing in lieu of the vending machine 14. In this case the securely exchanged device identifier and point configuration may be used to limit communication of data between the two devices, for example, by encryption based on these data elements.

In the former case of a purchase through a vending machine 14, when the consumer/owner of the smart phone 10 makes an order using controls on the vending machine 14 or the input touchscreen 20 of the smart phone 10, a purchase message 55 may be sent to the commerce computer 40 from the vending machine or the smart phone 10. The commerce computer 40 then confirms that a payment can be authorized for the amount of the purchase, for example, through a pre-established credit system having an account linked to the owner of the smart phone 10.

If the necessary credit or debit authority is established at the commerce computer 40, a release message 56 may he sent to the vending machine 14 so that it will mechanically release the physical product being ordered by the consumer and owner of the smart phone 10. A purchase confirmation 58 is then sent to the smart phone 10 to confirm completion of the transaction. Note that this system does not require a near field communication channel; however, a near field communication channel may be used as part of the communication chain for any of the message transmissions described above.

Generally, the ability to make a purchase after the accept order message 54 will be limited to a predetermined time, for example two minutes, and/or will expire at a predetermined time after the last message has been exchanged for security reasons.

It will be appreciated that the commerce computer 40 may be implemented wholly or in part by a processor 60 contained in the vending machine 14 which may simply communicate with a separate credit agency to establish the necessary financial underpinnings of the transaction and that a particular location of the computer 40 is not required so long as there is spatial proximity between the touchscreen interface device 16 and the vending machine 14.

It will be appreciated that this method and apparatus is not restricted to vending machines but can be used for any similar authentication process performed. Further it will be understood that the term vending machine should be interpreted broadly to include machines that can dispense physical items of any kind including food, beverages cash, tickets or the like.

It will be appreciated that the smart phone 10 may be an equivalent device such as a tablet, watch, pendant or the like with a touchscreen.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor”, can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. An authenticating system comprising:
a portable device including:
(a) a wireless communication circuit for communicating with the portable electronic device;
(b) a touchscreen input device for communicating with the portable electronic device via touches on the touch screen; and
a terminal system providing:
(a) a stamp key for contacting a touchscreen to generate a multitouch point configuration on the touchscreen of multiple touch points having predetermined relative displacements;
(b) a communication circuit receiving communications from the wireless communication circuit of a portable device; and
(c) a processor executing a stored program to:
(i) receive the point configuration from the portable device when the portable device has its touchscreen pressed against the stamp key via the communication circuit together with a unique identifier of the portable device; and
(ii) compare the point configuration to the stamp key and if they match communicate data with the portable device using the communication circuit on a channel that is authenticated to the unique identifier of the portable device.

2. The authenticating system of claim I wherein the wireless communication circuit employs a near field communication channel having a working range of less than 2 meters.

3. The authenticating system of claim 2 wherein the near field communication channel uses a low power radio frequency signal.

4. The authenticating system of claim 1 wherein the stamp key is spatially associated with the communication circuit.

5. The authenticating system of claim 1 wherein the data communicated by the communication circuit and the touches on the touch screen from the touchscreen input device must occur within a predetermined time window.

6. The authenticating system of claim I wherein step (i) must he repeated after a predetermined time of ceasing of data communication between the terminal system and the portable device.

7. The authenticating system of claim 1 wherein the terminal system is associated with a vending machine and the data communication relates to a purchase of product from the vending machine including identification of a payment source and a release of product from the vending machine.

8. The authenticating system of claim 7 wherein a vending machine dispenses a product selected from the group consisting of a food, a beverage, cash, and physical tickets.

9. The authenticating system of claim 8 wherein the stamp key is attached to a housing of the vending machine.

10. The authenticating system of claim 1 wherein the processor is within the terminal.

11. The authenticating system of claim 1 wherein the processor is remote from the terminal and communicates with the terminal via a wireless communication channel.

12. The authenticating system of claim 1 wherein the point configuration is encrypted.

13. The authenticating system of claim 1 wherein encryption is a public-key encryption.

14. The authenticating system of claim 1 wherein the unique identifier is encrypted.

15. A method of authenticating a transaction comprising:
(a) touching a touchscreen of a portable device against a stamp key spatially located with respect to a terminal;
(b) transmitting from the portable device a point configuration derived from touches generated on the touchscreen by the stamp key together with identification of the portable device; and
(c) receiving the point configuration and identification of the portable device at a terminal computer to compare the point configuration to the stamp key and if they match communicating data with the portable device on a channel is limited to the unique identifier of the portable device.
